(19) United States
(12) Patent Application Publication
(10) Pub. No.: US 2024/0148116 A1
(43) Pub. Date: May 9, 2024

(54) SPLICING CLASP FOR JEWESLY

(71) Applicant: TIAN XIE, Guangzhou (CN)

(72) Inventor: TIAN XIE, Guangzhou (CN)

(21) Appl. No.: 18/175,624

(22) Filed: Feb. 28, 2023

(30) Foreign Application Priority Data
Nov. 9, 2022 (CN) 202222980945.7

(51) Int. Cl. A44C 5/20

(52) U.S. Cl. CPC A44C 5/2019

(57) ABSTRACT

The present application discloses a splicing clasp for jewelry, comprising a clasp body, one side of the clasp body is connected with the jewelry, and other side is provided with an opening for fastening the clasp body with the clasp body, and both ends of the clasp body at the opening are provided with inclined surfaces, the inclined surfaces on the ends of the clasp body is inclined towards a direction of the opening, and an inclined angle range of the inclined surface is 100-170 degrees.

### CROSS-REFERENCE TO RELATED APPLICATIONS

This is a U.S. patent application which claims the priority and benefit of Chinese Patent Application Number 202222980945.7, filed on Nov. 9, 2022, the disclosure of which is incorporated herein by reference in its entirety.

### TECHNICAL FIELD

The present application relates to the field of jewelry clasps, in particular to a splicing clasp for jewelry.

### BACKGROUND

Both ends of the existing metal jewelry are fastened by lobster clasps to achieve the effect of being easy to wear. As shown in FIG. 1, since the fastening and opening of the lobster clasp requires pressing the spring inside the lobster clasp, multiple pressings will easily damage the spring. In addition, as shown in FIG. 2, if other objects need to be matched with the existing metal jewelry, a closed-loop clasp is provided on the metal jewelry to hang and match other objects. Since the closed-loop clasp has no opening, it cannot be disassembled and assembled to change the shape. The wearer can only wear a fixed shape, and cannot freely match other decorations according to his/her own preferences. Therefore, more money is required to buy different metal jewelry shapes, which not only requires more expense, but also is very inconvenient to store.

### SUMMARY

The purpose of the present application is to provide a splicing clasp for jewelry which is not easy to be damaged and is convenient for replacing other jewelry items.

The j splicing clasp for jewelry described in the present application comprises a clasp body, wherein one side of the clasp body is connected with the jewelry, and other side is provided with an opening for fastening the clasp body with the clasp body, and both ends of the clasp body at the opening are provided with inclined surfaces, the inclined surfaces on the ends of the clasp body is inclined towards a direction of the opening, and an inclined angle range of the inclined surface is 100-170 degrees.

As a preferred solution of the present application, chamfers are provided at the end of the clasp body on the inclined surface.

As a preferred solution of the present application, one side of the clasp body is fixedly connected with the jewelry.

As a preferred solution of the present application, one side of the clasp body is detachably connected with the jewelry.

As a preferred solution of the present application, the shape of the clasp body is circular.

As a preferred solution of the present application, the shape of the clasp body is ellipse.

As a preferred solution of the present application, the shape of the clasp body is triangular.

As a preferred solution of the present application, the clasp body is made of metal.

As a preferred solution of the present application, two inclined surfaces are arranged on the end of the clasp body.

As a preferred solution of the present application, four inclined surfaces are arranged on the end of the clasp body.

The present application can solve the problem that the spring is easily damaged when the lobster clasp is pressed repeatedly. At the same time, the present application can solve the problem that the closed-loop clasp cannot be disassembled and assembled to change the shape, and the wearer can only wear a fixed shape and cannot freely match other decorations according to his own preferences. Therefore, more money is needed to buy different metal jewelry shapes. This not only requires more expenses, but also is very inconvenient to store. The present application can achieve the effects of not being damaged easily and making it easy to replace other jewelry items. In addition, by setting the inclination angle of the inclined surface to 100-170 degrees, it is convenient to insert and fasten the clasp bodies from their respective openings.

### BRIEF DESCRIPTION OF DRAWINGS

FIG. 1 is a schematic structural diagram of the connection between the lobster clasp and the metal jewelry at present;

FIG. 2 is a structural diagram of present lobster clasp;

FIG. 3 is a schematic structural diagram of the connection between the closed-loop clasp and the metal jewelry at present;

FIG. 4 is a structural diagram of closed-loop clasp at present;

FIG. 5 is a schematic structural diagram of the splicing clasp for jewelry with two inclined surfaces according to the present application;

FIG. 6 is a schematic structural diagram of the connection between the splicing clasp for jewelry with two inclined surfaces and jewelry according to the present application;

FIG. 7 is a schematic structural diagram of the splicing clasp for jewelry with four inclined surfaces according to the present application;

FIG. 8 is a schematic structural diagram of the connection between the splicing clasp for jewelry w with four inclined surfaces and the jewelry according to the present application.

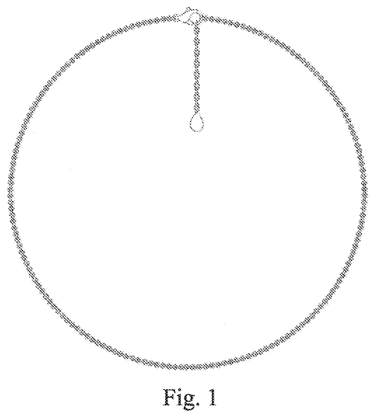

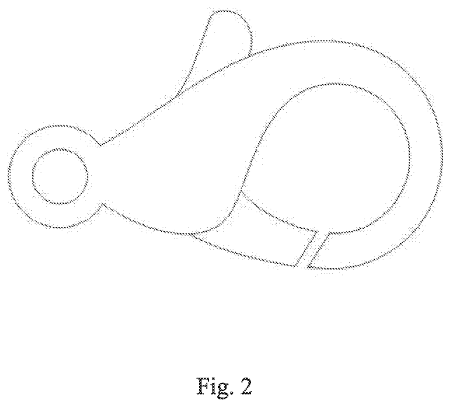

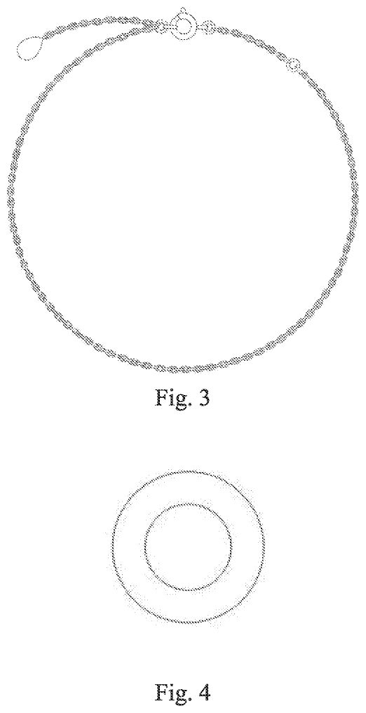

### REFERENCE SIGNS

1. Clasp body; 2. Opening; 3. End of the Clasp body; 4. Inclined surface; 5. Chamfer.

### DETAILED DESCRIPTION

The technical solutions in the embodiments of the present application will be clearly and completely described below in conjunction with the accompanying drawings. Apparently, the described embodiments are only some of the embodiments of the present application, rather than all the embodiments. Based on the embodiments in the present application, all other embodiments obtained by persons of ordinary skill in the art without creative efforts fall within the protection scope of the present application.

In the present application, it needs to be explained that if there are directional indications (such as up, down, left, right, front, back, top, bottom, inside, outside, vertical, transverse, longitudinal, counterclockwise, clockwise, circumferential, radial, axis) in the embodiment of the present application, the directional indication is only used to explain the relative positional relationship and movement of the components in a certain posture (as shown in the attached figure). If the specific posture changes, the directional indication also changes accordingly.

In one of the embodiments, the splicing clasp for jewelry comprises a clasp body 1, wherein one side of the clasp body is connected with the jewelry, and other side is provided with an opening 2 for fastening the clasp body with the clasp body, and both ends of the clasp body at the opening are provided with inclined surfaces 4, the inclined surfaces on the ends 3 of the clasp body is inclined towards a direction of the opening, and an inclined angle range of the inclined surface is 100-170 degrees. By setting the inclination angle of the inclined surface within a range of 100-170 degrees, it is convenient to insert and fasten the clasp bodies from their respective openings.

The splicing clasp for jewelry can solve the problem that the spring is easily damaged when the lobster clasp is pressed repeatedly. At the same time, the present application can solve the problem that the closed-loop clasp cannot be disassembled and assembled to change the shape, and the wearer can only wear a fixed shape and cannot freely match other decorations according to his own preferences. Therefore, more money is needed to buy different metal jewelry shapes. This not only requires more expenses, but also is very inconvenient to store. The present application can achieve the effects of not being damaged easily and making it easy to replace other jewelry items.

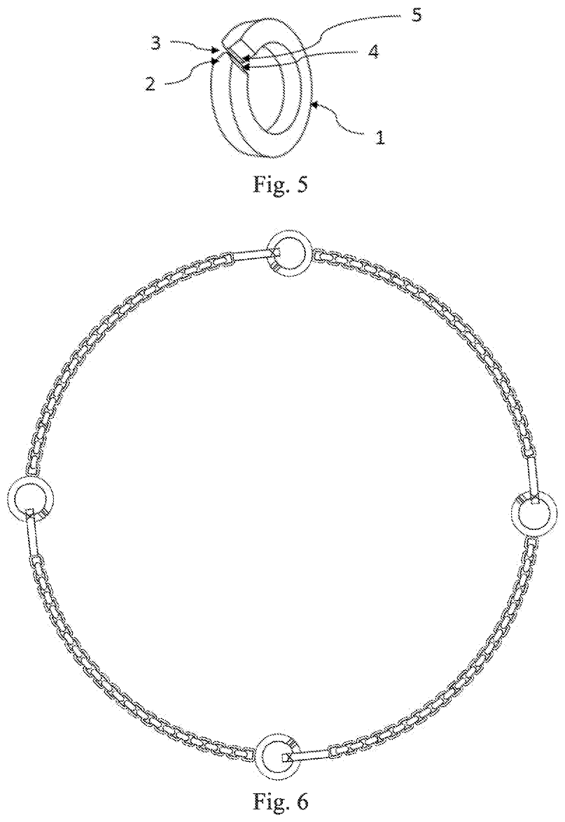

In one of the embodiments, the splicing clasp for jewelry comprises a clasp body 1, wherein one side of the clasp body is connected with the jewelry, and other side is provided with an opening 2 for fastening the clasp body with the clasp body, and both ends of the clasp body at the opening are provided with two inclined surfaces 4, the inclined surfaces on the ends 3 of the clasp body is inclined towards a direction of the opening. Through the two inclined surfaces 4, it is convenient to insert and fasten the clasp body and the clasp body from their respective openings. As shown in FIG. 5 and FIG. 6, the shape of the clasp body can be configured as a circle, an ellipse or a triangle, etc.

In addition, chamfers 5 are provided at the end of the clasp body on the inclined surface, which further facilitates the insertion and fastening of the clasp bodies from their respective openings.

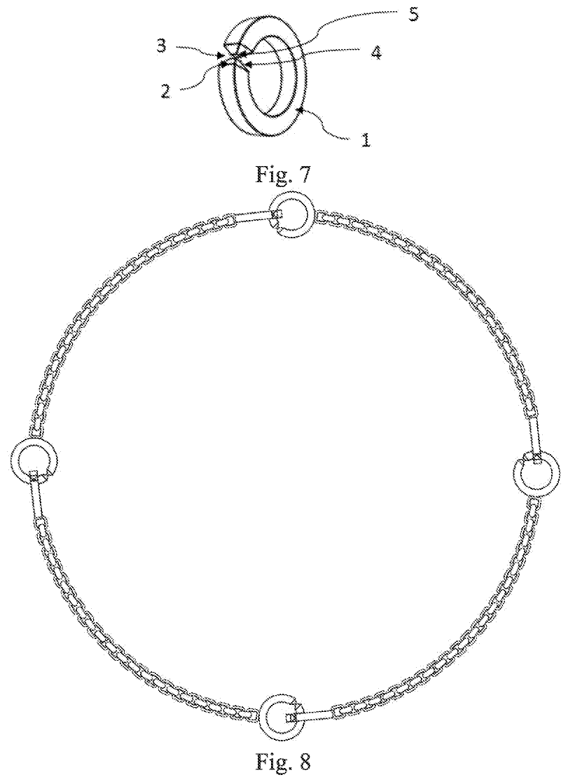

In one of the embodiments, the splicing clasp for jewelry comprises a clasp body 1, wherein one side of the clasp body is connected with the jewelry, and other side is provided with an opening 2 for fastening the clasp body with the clasp body, and both ends of the clasp body at the opening are provided with four inclined surfaces 4, the inclined surfaces on the ends 3 of the clasp body is inclined towards a direction of the opening. Through the four inclined surfaces 4, it is convenient to insert and fasten the clasp body and the clasp body from their respective openings as shown in FIG. 7 and FIG. 8.

In one of the embodiments, one side of the clasp body is fixedly connected with the jewelry, so that the jewelry and the clasp body can be integrated more stably, preventing the jewelry from falling and being lost.

In one of the embodiments, one side of the clasp body is detachably connected to the jewelry, so that the jewelry can be separated from the clasp body more easily, and is convenient for disassembly and replacement.

What is claimed is:

1. A splicing clasp for jewelry, comprising a clasp body (1), wherein one side of the clasp body is connected with the jewelry, and other side is provided with an opening (2) for fastening the clasp body with the clasp body, and both ends of the clasp body at the opening are provided with inclined surfaces (4), the inclined surfaces on the ends (3) of the clasp body is inclined towards a direction of the opening, and an inclined angle range of the inclined surface is 100-170 degrees.

2. A splicing clasp for jewelry according to claim 1, wherein chamfers (5) are provided at the end of the clasp body on the inclined surface.

3. A splicing clasp for jewelry according to claim 1, wherein one side of the clasp body is fixedly connected with the jewelry.

4. A splicing clasp for jewelry according to claim 1, wherein one side of the clasp body is detachably connected with the jewelry.

5. A splicing clasp for jewelry according to claim 1, wherein the shape of the clasp body is circular.

6. A splicing clasp for jewelry according to claim 1, wherein the shape of the clasp body is ellipse.

7. A splicing clasp for jewelry according to claim 1, wherein the shape of the clasp body is triangular.

8. A splicing clasp for jewelry according to claim 1, wherein the clasp body is made of metal.

9. A splicing clasp for jewelry according to claim 1, wherein two inclined surfaces are arranged on the end of the clasp body.

10. A splicing clasp for jewelry according to claim 1, wherein four inclined surfaces are arranged on the end of the clasp body.
